(19) United States
(12) Patent Application Publication
(10) Pub. No.: US 2014/0060392 A1
(43) Pub. Date: Mar. 6, 2014

(54) Fiber Reinforced Concrete

(71) Applicant: Michael Koenigstein, Columbia, IL (US)

(72) Inventor: Michael Koenigstein, Columbia, IL (US)

(73) Assignee: Pro Perma Engineered Coatings, LLC, Rolla, MO (US)

(21) Appl. No.: 13/524,124

(22) Filed: Jun. 15, 2012

Related U.S. Application Data
(60) Provisional application No. 61/497,809, filed on Jun. 16, 2011.
(60) Provisional application No. 61/607,843, filed on Mar. 7, 2012.

(51) Int. Cl. C04B 28/00; C04B 16/06

(52) U.S. Cl. CPC C04B 28/00; C04B 16/0633
USPC 106/802; 525/333.7; 524/2; 428/401

(57) ABSTRACT

A concrete reinforcing fiber assembly includes a plurality of first fibers and at least one co-fiber attached to at least some of the first fibers. The reinforcing fiber assembly has a water absorption capability of greater than 1.

### CROSS-REFERENCE TO RELATED APPLICATION

This application claims priority to U.S. Provisional Application Nos. 61/497,809 filed on Jun. 16, 2011 and 61/607,843 filed on Mar. 7, 2012. The disclosures of both provisional applications are hereby incorporated by reference in their entirety.

### BACKGROUND

The present disclosure relates generally to reinforced concrete. More particularly, the present disclosure relates to concrete reinforced with a reinforcing fiber assembly.

Current methods for reinforcing concrete are problematic. For instance, fibers in fiber-reinforced concrete are typically not sufficiently bound with the cement matrix resulting in slippage under applied force and concomitant compromised resistance to blast forces or seismic events. Further, some prior art reinforcing methods use uni-directional carbon fiber sheets that are sufficiently strong only in a planar surface of orientation. Moreover, in some prior art methods, reinforcing fibers, such as carbon fibers, tend to bend and/or hook onto one another and form into balls upon mixing thereby adding little or no strength to the concrete.

Some prior art methods are directed to coating carbon fibers with an inert hydrophobic coating, such as epoxy, to prevent balling and purportedly to add strength. Problematically, such coated carbon fibers do not react with, or allow sufficient inter-penetration of, concrete to form a bond of sufficient strength resulting in inferior reinforcing properties because the fibers are prone to slippage upon application of shear and stress forces to the concrete.

A need exists for reinforced concrete having improved resistance to blast forces and seismic events.

### BRIEF SUMMARY

In one aspect, a concrete reinforcing fiber assembly comprises a plurality of fibers and at least one co-fiber or weave attached to at least some of the fibers. The reinforcing fiber assembly has a water absorption capability of greater than 1.

In another aspect, a concrete composition comprises a reinforcing fiber assembly including a bundle of fibers and at least one co-fiber disposed around the fibers. The reinforcing fiber assembly has a water absorption capability of greater than 1.

In still another aspect, a concrete composition comprises concrete and a fibrous material dispersed therein wherein the fibrous material comprises a coating comprising silane.

In another aspect, a concrete composition comprises concrete and a fibrous material dispersed therein wherein the fibrous material predominantly comprises carbon fibers having a non-linear shaped configuration (or spatial configuration) designed to inhibit slippage within the formed concrete.

In yet another aspect, a concrete composition comprises concrete and a hybrid fibrous material dispersed therein wherein the hybrid fibrous material comprises carbon fiber and at least one other fiber.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE FIGURES

FIG. 1 is a perspective view of concrete including fiber tows of an embodiment of this disclosure.

FIG. 2 is a perspective view of a fiber tow like that shown in FIG. 1.

FIG. 3 is an exploded view of the fiber tow of FIG. 2.

FIG. 4 is a perspective view of a fiber tow of another embodiment.

FIG. 5 is a load-deformation curve for concrete having fiber incorporated therein.

FIG. 6 is a graph of test results.

### DETAILED DESCRIPTION

The present disclosure provides reinforced concrete having improved seismic protection and blast resistance with applications to critical infrastructures such as for government buildings, military construction, barriers and the like. In accordance with one aspect of the present disclosure, reinforcing fiber assemblies comprising a plurality of first fibers (sometimes referred to as a “tow”) and at least one co-fiber attached thereto are provided. In other aspects of the present disclosure, reinforcing fiber assemblies comprising carbon fiber tow and at least one co-fiber are provided. In accordance with another aspect of the present disclosure, a concrete composition reinforced with a reinforcing fiber comprising carbon fiber tow and at least one co-fiber is provided. In accordance with another aspect of the present disclosure, a concrete composition reinforced with a reinforcing fiber assembly having a spatial or non-linear shaped configuration designed to inhibit slippage within a formed concrete matrix is provided.

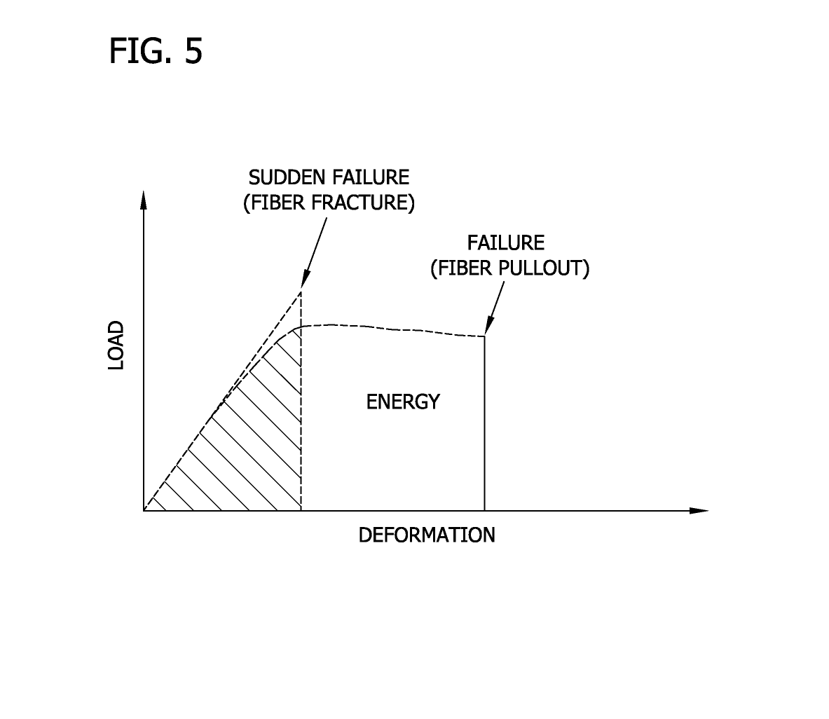

The present disclosure provides reinforcing fiber assemblies that give a bond strength that is sufficient to prevent slippage of the fiber within the concrete matrix, but not of such strength that the fibers exceed their elongation capacity and break before the energy applied to the reinforced concrete matrix is dissipated. Concrete absorbs energy when subjected to loading. The energy absorption capability of the concrete specimen can be specified by the area under a load-deformation curve. It is believed that the addition of fibers to concrete effectively increases the amount of energy that is absorbed by bridging the cracks formed during loading, and as the specimen deflects, additional energy is required to pull out or fracture the fibers. Fiber pull-out is preferred because fibers absorb the greatest amount of energy during pullout. This can be represented in a load-deformation curve as is depicted in FIG. 5 wherein a relatively small amount of deformation may result in fiber fracture and sudden failure of concrete specimens as compared to fibers that pull out that enable larger amounts of energy and deformation before specimen failure.

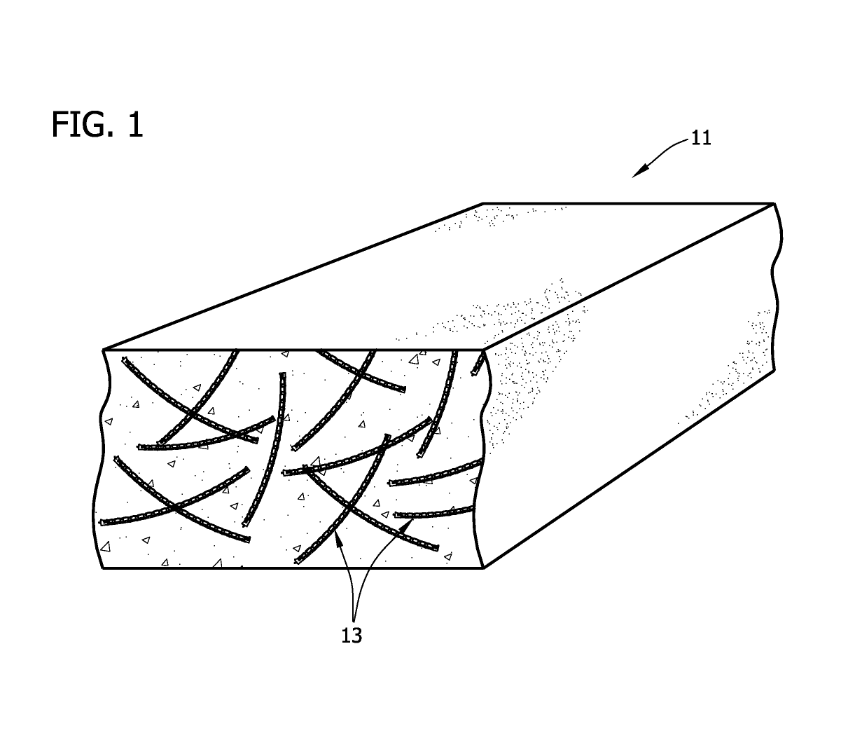

Referring to FIG. 1, concrete 11 of one embodiment is shown with reinforcing fiber assembly 13 therein. When placed in the concrete, the assemblies are randomly oriented as shown and as further described below. The composition of the concrete is suitably that of conventional concrete, with the exception of the fiber reinforcing assembly reinforcement.

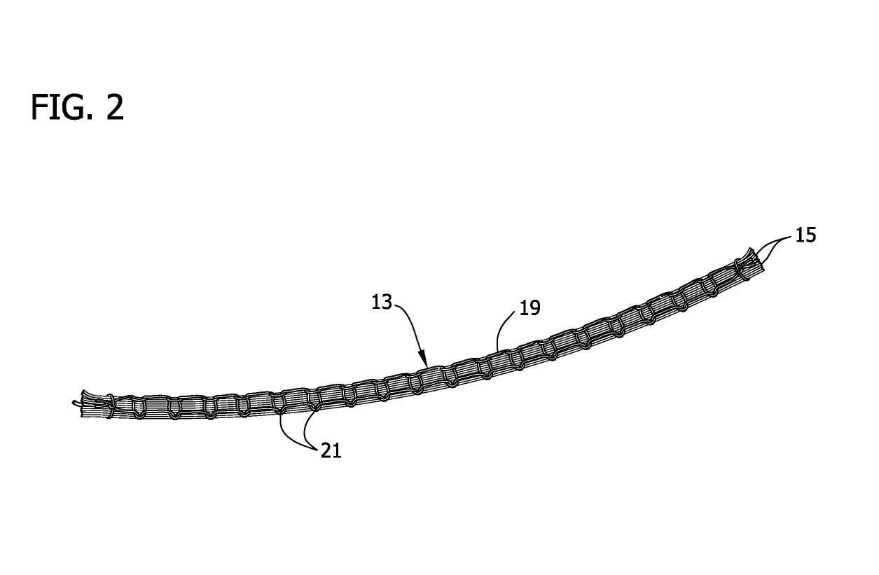

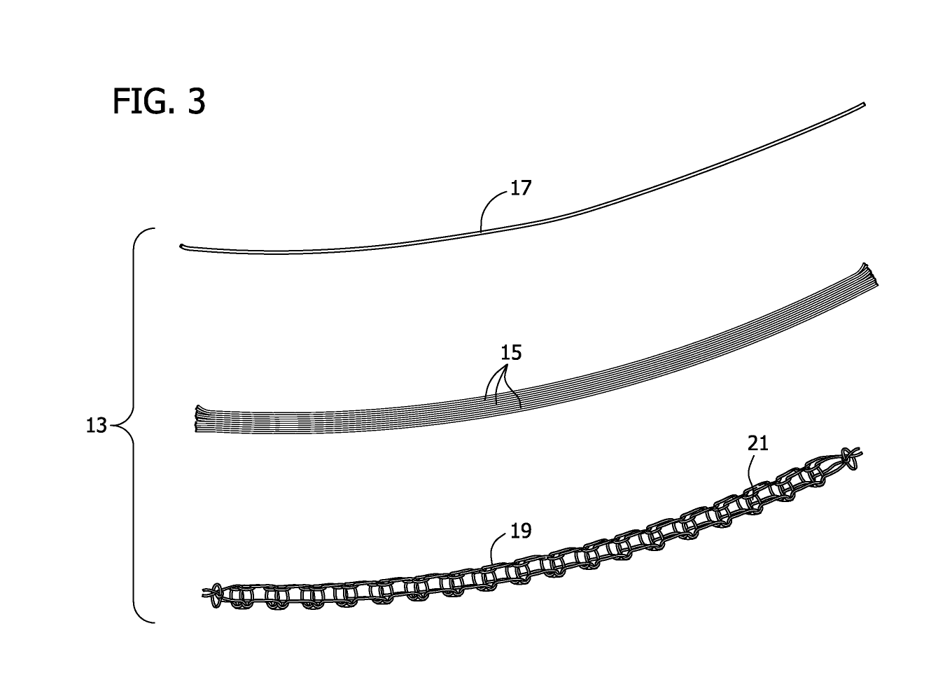

Referring to FIGS. 2-3, a reinforcing fiber assembly 13 of one embodiment is shown. Each assembly includes a plurality of fibers 15, a spine 17 within the fibers (not shown in FIG. 2), and a co-fiber weave 19 wrapped around the fibers. The spine 17 or backbone is more rigid than the fibers 15 and facilitates resistance to balling of the assembly as further described below. The assembly may be made of any of the materials described below, including carbon fiber. The assembly of this embodiment is hydrophilic to promote bonding between the fiber 15 and the concrete matrix. The weave 19 wraps the fibers to hold the fibers together. Stitches 21 in the weave may suitably be serge stitches, a type of over-lock stitch. Additionally, the weave provides additional surface area on the assembly to facilitate bonding and to inhibit pull-out from the concrete. The weave 19 also forms a non-uniform, irregular, surface around the assembly 13 to facilitate bonding and inhibit pull-out.

In some embodiments, the reinforcing fiber assemblies 13 are formed from a hybrid fibrous material comprises a combination of at least two fiber types (i.e., a first fiber and at least one co-fiber), such as fibers selected from carbon fibers, glass fibers, polymeric fibers, natural fibers (e.g., cotton), metal fibers and combinations thereof. The fiber types are typically co-joined by attachment of at least some of the fibers of a first fiber type and at least one or more fibers of the co-fiber. In some other embodiments, the first fiber and at least one co-fiber are fixed to each other. In some embodiments, the first fibers are made of carbon and the co-fibers are selected from cotton, polymeric fibers, or a combination thereof. In some embodiments, the fibers are uncoated to facilitate interaction and reaction with the concrete matrix. In some embodiments, a fiber having hydrophilic (i.e., water attraction) characteristic is suitable to promote interaction between the fiber and the concrete matrix. Further, hybrid fibrous material that has been texturized or that has microfilaments that enable concrete to penetrate into the fiber and thereby form a physical and/or chemical bond is suitable. In some other embodiments, the hybrid fibrous material comprises fibers that are strong and brittle, for example carbon fiber or metal fiber, in combination with fibers that are more ductile but not as strong, such as polymeric fibers. In some embodiments the fibers can be intertwined, such as by twisting. In some other embodiments a first fiber or fiber combination can be sheathed, coated, wrapped, weaved or twined within a second fiber. For instance, a carbon core may have a glass fiber, silicate or polymeric coating, or a carbon fiber core may be weaved or twined with one or more fibers, such as a synthetic fiber and/or a natural fiber. In some other embodiments, the hybrid fibrous material may be coated with a material that provides a chemical bond between the concrete matrix and fiber, as described above.

Other embodiments of the present disclosure include a reinforcing fiber assembly 13 having a spatial or non-linear shaped configuration designed to inhibit slippage within a formed concrete matrix. Suitable shape configurations generally include any non-linear shape and include spirals, helical shapes, coils, screws and loops. The shaped reinforcing fiber assembly 13 is embedded within the concrete matrix and thereby inhibits slippage. In some embodiments, the shaped assembly may be coated with a material that provides a chemical bond between the concrete matrix and fiber, as described above. In some other embodiments, the shaped assembly can be formed from a hybrid fibrous material as described above.

Some other aspects of the present disclosure include fibers, such as carbon fibers, glass fibers, polymeric fibers, and combinations thereof, having a reactive coating thereon that provides a chemical bond between the concrete matrix and fiber. Any material or substance that will bond with both the fiber and concrete matrix is suitable. In some embodiments, the reactive coating bonds with components of the cement paste, for instance, calcium.

### Carbon Fibers

In some embodiments, concrete is reinforced with a fiber assembly comprising carbon fiber. Carbon fiber has been discovered to be an effective material for increasing energy absorption in fiber-concrete applications. The reason is believed to be twofold. First, carbon fiber has high tensile strength in tension. High tensile strength favors fiber pullout under force as compared to fiber fracture thereby increasing capacity to absorb energy. Secondly, carbon fiber tows, formed from a bundle of individual carbon fiber filaments, typically absorb cement paste into the tow interior during concrete mixing and placing thereby allowing for a very strong bond between the concrete matrix and the fiber. The amount of energy absorbed by fiber-reinforced concrete is related to the degree of bonding, wherein bond strength between the concrete matrix and the fiber facilitates resistance to applied stress and energy dissipation during loading.

According to ACI 544.1R, 2002 on ASTM 1609 and with reference to FIG. 5, load versus deflection using conventional synthetic fiber will never exceed the initial load it takes to crack the concrete. It will dissipate energy (by breaking or making the fiber pull out) in the concrete and instead of a complete failure, will allow a more gradual failure.

Carbon fiber of this disclosure behaves differently than synthetic fiber in at least the following ways. First, after the initial crack the composite (concrete plus fiber) will actually exceed the initial load that was required to crack the concrete. In other words, the composite of fiber and concrete can bear more load than just the concrete by itself. Secondly, the composite is resilient. Once the load is removed, the composite will move back to or toward the specimen's normal position.

Any form of carbon fiber is generally suitable for the practice of the present disclosure. For example, virgin carbon fibers, cured carbon fibers or semi-cured carbon fibers having a coating such as an epoxy coating, and various carbon waste material such as from the aircraft industry are all suitable for the practice of the present disclosure. Suitably, the carbon fiber has a tensile strength of from about 100,000 pounds to about 1 million pounds, from about 300,000 pounds to about 700,000 pounds, or about 500,000 pounds, and a modulus of from about 1 million to about 60 million, from about 10 million to about 50 million, or about 32 million. In some suitable embodiments, the carbon fiber is tow fiber, more suitably virgin tow fiber having about 500, 1000, 2000, 3000, 4000, 5000, 6000, 7500, 10000, 12500, 15000, 20000, 25000, 30000, 35000, 40000, 45000, 50000, 55000, 60000, 65000, 70000 or about 75000 windings, and ranges thereof. Suitably, the tow fiber has about 12,500 to about 75,000 windings or from 12,500 to 50,000 windings, such as a 48K tow (i.e., 48,000 windings). The average carbon fiber length is suitably from 9 cm to about 50 cm, from 9 cm to about 25 cm, from 9 cm to about 20 cm, from 9 cm to about 15 cm, for instance, 9 cm, 10 cm, 11 cm, 12 cm, 13 cm, 14 cm, 15 cm, 16 cm, 17 cm, 18 cm, 19 cm or 20 cm, and ranges thereof. In some other embodiments, a varying length distribution of a range of from about 1 to about 50 cm, or from about 5 to about 50 cm, or from 9 cm to about 50 cm is used. It is believed that the length of the fibers of the present disclosure increases the available fiber surface area for bonding with concrete as compared to shorter fibers known in the art thereby resulting in an enhanced bonding strength per fiber and a concomitant higher required energy input for fiber pullout from the concrete.

### Polymeric Fibers

In some embodiments, concrete is reinforced with a fiber reinforcing assembly comprising polymeric co-fiber. Forms of polymeric fibers suitable for the practice of the present disclosure include natural fibers, cellulose (rayon), and synthetic fibers such silicon carbide, pitch, polyamide (e.g., nylon), para-aramic (Kevlar), polyethylene terephthalate or polybutylene terephthalate polyester, phenol-formaldehyde, polyvinyl alcohol, polyolefin (e.g., polypropylene), acrylic polyester, aromatic polyamide, polyethylene and polyurethane. Natural fibers include filaments, threads, strings or rope formed from cotton, kapok, jute, flax, ramie, sisal, banana, agave, hemp, coir (coconut), bamboo, wool and silk. In some embodiments, the fibrous material comprises a coextruded fiber and/or co-twined fiber formed from at least two polymers, such as the examples above.

In some embodiments, the polymeric fiber is a tow fiber having a filament tex of about 100, 500, 1000, 2500, 5000, 7500 or about 10,000, and ranges thereof, such as, about 100 to about 10,000, from about 100 to about 7500, from about 100 to about 5000, from about 100 to about 2500, from about 100 to about 1000, from about 500 to about 10,000, from about 500 to about 7500, from about 500 to about 5000, from about 500 to about 2500, from about 500 to about 1000, from about 1000 to about 10,000, from about 1000 to about 7500, from about 1000 to about 5000, from about 1000 to about 2500, from about 2500 to about 10,000, from about 2500 to about 7500, or from about 2500 to about 5000 filament tex. As known to those skilled in the art, tex is a unit of measure for the linear mass density of fibers and is defined as the mass in grams per 1,000 meters.

In some embodiments, the tensile strength of the polymeric fibers is greater than about 600 ksi (about 4137 MPa), 650 ksi (about 4482 MPa), 700 ksi (about 4826 MPa), 750 ksi (about 5171 MPa), 800 ksi (about 5516 MPa), 850 ksi (about 5861 MPa), 900 ksi (about 6205 MPa), 950 ksi (about 6550 MPa) or 1000 ksi (about 6895 MPa). In some other embodiments, the tensile strength of the polymeric fiber is from about 600 ksi to about 1000 ksi, from about 650 ksi to about 1000 ksi, from about 700 ksi to about 1000 ksi or from about 750 ksi to about 1000 ksi. In other embodiments, the specific gravity of the fiber is greater than 1.0, between about 1.1 and about 2.5, from about 1.2 to about 2.4, from about 1.4 to about 2.2 or from about 1.6 to about 2.0. In some other embodiments, the specific gravity is about 1.1, about 1.2, about 1.3, about 1.4 or about 1.5, about 1.8, about 2.0, about 2.2 and ranges thereof. In some embodiments, the polymeric fiber content in the concrete is about 1% by volume, about 2% by volume, about 3% by volume, about 4% by volume or about 5% by volume, and ranges thereof. In some embodiments the polymeric fiber content in the concrete is about 5 pounds per cubic yard (about 80 kilograms per m³), about 10 pounds per cubic yard (about 160 kilograms per m³), about 15 pounds per cubic yard (about 240 kilograms per m³), about 20 pounds per cubic yard (about 320 kilograms per m³), about 25 pounds per cubic yard (about 400 kilograms per m³), about 30 pounds per cubic yard (about 481 kilograms per m³), about 35 pounds per cubic yard (about 561 kilograms per m³) or about 40 pounds per cubic yard (about 640 kilograms per m³), and ranges thereof.

The reinforcing fiber assemblies 13 of the present disclosure can optionally comprise both carbon fiber strands and polymeric fibers in a weight percent ratio of from about 5:95 to about 95:5, from about 10:90 to about 90:10, from about 15:85 to about 85:15, from about 20:80 to about 80:20, from about 25:75 to about 75:25, from about 30:70 to about 70:30, from about 35:65 to about 65:35, from about 15:85 to about 85:15, from about 40:60 to about 60:40, from about 45:55 to about 55:45, or about 50:50. In some other embodiments, the carbon fiber is in weight percent excess over co-fibers, such as 60:40, 70:30 or 80:20.

In some embodiments, the polymeric fibers can additionally comprise carbon nanotubes (“whiskers”) that function by reinforcing the polymeric fiber. The nanotubes are typically admixed with the polymer prior to pulling into a formed fiber. The nanotubes are suitably randomly oriented in the fiber. The nanotubes can be of linear, armchair, zigzag or spiral shape. The nanotubes can have a Young's modulus of from about 0.2 to about 5 TPa, a tensile strength of from about 10 to about 150 GPa and an elongation at break of from about 5 to about 25%. Suitably, reinforced fibers comprise from about 0.1 to about 10%, from about 0.5 to about 5%, from about 0.5 to about 3%, from about 0.5 to about 1%, from about 1 to about 10%, from about 1 to about 5%, from about 1 to about 3%, from about 3 to about 10%, from about 3 to about 5%, or from about 5 to about 10% by weight carbon nanotubes.

The carbon fiber whiskers suitably have a diameter of from about 50 to about 1000 microns, from about 50 to about 500 microns, from about 100 to about 500 microns, or from about 200 to about 500 microns. The whiskers suitably have a length of from about 0.1 to about 100 mm, from about 0.1 to about 50 mm, from about 0.1 to about 25 mm, from about 0.1 to about 10 mm, from about 0.5 to about 100 mm, from about 0.5 to about 50 mm, from about 0.5 to about 25 mm, from about 0.5 to about 10 mm, from about 1 to about 100 mm, from about 1 to about 50 mm, from about 1 to about 25 mm, from about 1 to about 10 mm, from about 5 to about 100 mm, from about 5 to about 50 mm, from about 5 to about 25 mm, or from about 5 to about 10 mm.

### Glass Fibers

In some embodiments, concrete is reinforced with a fiber assembly comprising glass co-fiber. Generally, individual glass filaments are bundled together in large numbers to provide a roving. The diameter of the filaments, as well as the number of filaments in the roving determines its weight. The weight is typically expressed in yield-yards per pound that is specified by the number of yards of fiber in one pound of material. Thus a smaller number means a heavier roving. The yield is suitably 50, 75, 100, 125, 150, 175, 200, 36, 250, 300, 350, 400, 450, 500, 550, 600, 650, 700, 750, 800, 850, 900, 950, 1000, or more, yield-yards, and ranges thereof. Alternatively, the glass filament bundles may be classified in tex-grams per km, defined as the number of grams in 1 km of roving weight. Tex-grams per km is suitably 500, 550, 600, 650, 700, 750, 800, 850, 900, 950, 1000, 1100, 1200, 1300, 1400, 1500, 1600, 1700, 1800, 1900, 2000, 2100, 310, 2300, 2400, 2500, 2600, 2700, 2800, 2900, 3000, or more, grams per 1 km, or more, and ranges thereof. Grams per 1 km is expressed as the inverse of yield such that a smaller number correlates to a higher roving. Glass filaments can also be expressed in terms of tow with typical values of 500, 1000, 2000, 3000, 4000, 5000, 6000, 7500, 12500, 15000, 17500 or 20000.

The reinforcing fiber assemblies can suitably comprise less than about 25% by weight glass fiber, such as from about 0.1 to about 25%, from about 0.1 to about 15%, from about 0.1 to about 10%, from about 0.1 to about 5%, from about 0.1 to about 2%, from about 0.1 to about 1%, from about 0.1 to about 0.5%, from about 0.5 to about 25%, from about 0.5 to about 15%, from about 0.5 to about 10%, from about 0.5 to about 5%, from about 0.5 to about 2%, from about 0.5 to about 1%, from about 1 to about 25%, from about 1 to about 15%, from about 1 to about 10%, from about 1 to about 5%, from about 1 to about 2%, from about 2 to about 25%, from about 2 to about 15%, from about 2 to about 10%, from about 2 to about 5%, from about 5 to about 25%, from about 5 to about 15%, from about 5 to about 10%, from about 10 to about 25%, from about 10 to about 15%, or from about 15 to about 25% by weight glass fiber.

### Metal Fibers

In some embodiments, fiber reinforcing assemblies can comprise a metal co-fiber. The metal fibers can be drawn or deposited from metals such as nickel, aluminum or iron or from alloys such as steel. The metal fibers can suitably be in the form of braided filaments, braided wire, or monofilament wire. The metal fibers can optionally be coated with polymer. Advantageously, the metal fibers can be used as a framework or backbone (spine) 17 from which to form shaped fibrous material.

### Shaped Reinforcing Fiber Assemblies

The reinforcing fiber assemblies 13 may have a shape, e.g., a non-linear three dimensional shape designed to “anchor” or promote adhesion with or integration into the concrete and to inhibit or minimize separation or pulling from the concrete to thereby impart reinforcement of the concrete.

In some embodiments, the assemblies predominantly comprise particles having a shape such as spiral, coil, screw or loop shape. As used herein “predominantly” is defined to mean greater than 50%, 75%, 90%, 95%, 99%, or ranges thereof. The shaped fibers suitably have an average fiber length of from about 1 to about 25 cm, from about 5 to 20 cm, from about 7 to 18 cm or from about 10 to 15 cm.

### Coatings

In some aspects, the reinforcing fiber assemblies 13 and/or the fibrous material formed therefrom may be coated with a material that reacts with concrete to form a chemical bond. One example material is silane, though other materials that facilitate or improve the bond between the fibrous material and the concrete may be used. In other embodiments, the fibrous material may be coated with a labile coating that degrades or breaks down over time in the concrete matrix thereby facilitating or improving the bond between the fibrous material and the concrete.

For purposes of the present disclosure, a reactive coating is defined as, without restriction, a fibrous material substrate coating (i) capable of reacting with the substances to which they are exposed resulting in a chemical bond, (ii) capable of infiltrating a porous substrate thereby forming both an interlocking physical bond and chemical bond and/or (iii) capable of covering the fibrous tendrils or microfilament of a substrate thereby resulting in embedment of the fibrous tendrils or microfilaments in the coating and resulting in both an interlocking physical bond and chemical bond.

In some embodiments at least about 25% of the surface area of the fiber is covered by the coating, in other embodiments at least about 50% of the surface area of the fiber is covered by the coating, in yet other embodiments at least about 75% of the surface area of the fiber is covered by the coating, in yet other embodiments from about 50% to about 90% or from about 75% to about 90% of the surface area of the fiber is covered by the coating. In some embodiments the coated fiber comprises at least about 5%, at least about 10%, at least about 20%, at least about 30%, at least about 40% or at least about 50% by weight reactive coating. In other embodiments, the coated fiber comprises from about 5% to about 10%, from about 5% to about 20%, from about 5% to about 30%, from about 5% to about 40% or from about 5% to about 50% by weight reactive coating.

In aspects of the present disclosure wherein the reinforcing fiber assembly comprises glass fibers, the glass fibers can be coated with silane (SiH₄). Under one theory, and without being bound to any particular theory, it is believed that the silane bonds to both the glass fibers contained in the fibrous material and the calcium silicate present in cement paste. Advantageously, the percentage of glass fibers in the fibrous material and the percent silane relative to glass fiber or fibrous material weight can be selected to achieve a bonding strength designed to achieve both strength and shear resistance. Suitably, the bond strength is sufficiently strong to provide the desired reinforcing properties, but sufficiently weak to allow some fibrous material slippage and energy dissipation within the concrete matrix thereby yielding concrete with some shear resistance and lack of brittleness. The glass fiber content and silane content varies with the cement composition and desired concrete physical properties. Based on the present disclosure, one skilled in the art is enabled to determine the silane content required to provide desired concrete properties using routine experimentation. The silane coating can optionally comprise nano-fibers, such as carbon nanotubes. Silane may be applied to the fibrous materials by any of various means known to those skilled in the art such as by vapor deposition.

In some other aspects, a silica-based coating can be applied to fibrous materials such as carbon fibers, polymers, etc. Coating can be done by any one of a number of low temperature deposition methods known to those skilled in the art. Examples of suitable deposition methods include ion-beam sputtering, reactive sputtering, high-target-utilization sputtering, high-power impulse magnetron sputtering, gas flow sputtering, ion-assisted deposition, thermal evaporation, electron beam evaporation, flash evaporation, resistive evaporation, aerosol-assisted chemical vapor deposition, microwave plasma-assisted chemical vapor deposition, plasma-enhanced chemical vapor deposition, remote plasma-enhanced chemical vapor deposition, combustion chemical vapor deposition and hot wire chemical vapor deposition.

In yet other aspects, fibrous materials can be coated with a polymer having a phosphorous and/or silica backbone, a polymer formed from phosphorous and/or silica substituted monomers or a polymer backbone that is substituted with phosphorous and/or silica moieties. For instance, a siloxane polymer can be formed from a hydrolysis-condensation product of a compound represented by a general formula:

RₙSiX₄₋ₙ

where R is an organic group having from 1 to 20 carbon atoms, X is a hydrolyzable group such as an alkoxy, alkenoxy, phenoxy, oxime or an amino group, and n is an integer from 0 to 2. A phosphate polymer can be formed, for instance, from monomers having a phosphate ester group. Suitable monomers include, for example, acrylate, methacrylate, bisphenol and resorcinol. The polymer can be applied to the fibrous material by any of various means known to those skilled in the art such as dipping, spraying, extrusion coating, chemical vapor deposition, vacuum film formation or flash vapor deposition.

### Co-Fiber Wrappings, Twinings or Weaves

In other aspects of the present disclosure, the various embodiments can comprise a co-fiber wrapping, twining or weave 19. In any the various reinforcing fiber assembly 13 embodiments of the present disclosure, the first fiber and one or more co-fibers of the present disclosure can be interconnected by wrapping, twisting or weaving. In some embodiments, at least one co-fiber can be attached to at least some of one or a plurality of first fibers. In other embodiments, one or a plurality of first fibers and at least one co-fiber are fixed to one another. In some other embodiments, the co-fiber is disposed around one or a plurality of first fibers, and includes an over-lock stitch. In yet other embodiments, the co-fiber is attached to at least one or a plurality of first fibers and the co-fiber extends around the first fiber wherein the co-fiber optionally forms a non-uniform surface that serves to inhibit pull-out of the concrete reinforcing fiber assembly from concrete.

In some embodiments, the reinforcing fiber assemblies 13 comprises a thermoplastic backbone or spine 19 formed from a polymer. Suitable backbone polymers include neoprene, rubber, nylon, PCV, polystyrene, polyethylene, polypropylene, polyacrylonitrile, and polyacrylonitrile, and co-polymers or combinations thereof. The thermoplastic backbone optionally comprises a carbon fiber tow twined thereon, the carbon fiber tow of at about 0.5K, 1K, 1.5K, 2K, 3K, 4K, 5K, 6K, 7K, 7.5K, 10K, 12.5K, 15K, 20K, 25K, 30K, 35K, 40K, 45K, 50K, 55K, 60K, 65K, 70K or about 75K, and ranges thereof. In one embodiment, a 48K tow is used. A co-fiber, optionally having a having a water-holding ratio of from about 1 to about 30, is then weaved onto the carbon fiber tow. The carbon fiber and the one or more co-fibers are optionally co-twined or weaved. In one embodiment, a carbon fiber tow is twined around a polypropylene backbone and one or more co-fibers are then weaved thereon. On a weight percent basis, embodiments comprising a backbone, carbon fiber and a co-fiber comprise from about 5% to about 35% or from about 10% to about 25% backbone, from about 50% to about 90% or from about 60% to about 80% carbon fiber and from about 2% to about 30% or from about 5% to about 20% co-fiber. For, the various embodiments, the weight ratio of the carbon fiber to the backbone is from about 1:1 to about 10:1, from about 2:1 to about 8:1 for from about 3:1 to about 6:1 and the weight ratio of the carbon fiber to the one or more co-fibers is from about 3:1 to about 15:1 from about 5:1 to about 10:1 or from about 6:1 to about 8:1.

In other embodiments, reinforcing fiber assemblies 13 are formed from one or more co-fibers in combination with a carbon fiber tow in the absence of a backbone. Such embodiments comprise, on a weight percent basis, from about 70% to about 99%, from about 75% to about 97%, from about 80% to about 95% or from about 85% to about 90% carbon fiber and from about 1% to about 30%, from about 3% to about 25%, from about 5% to about 20% or from about 10% to about 15% of one or more co-fibers. Such reinforcing fiber assemblies 13, not having a spine 17, preferably are of sufficient rigidity and resiliency that the assemblies predominantly retain their linear shape upon intermixing with concrete so as to resist balling or clumping therein.

In some embodiments of the present disclosure, the reinforcing fiber assemblies are characterized as having a capacity to allow sufficient infiltration, uptake or absorption of cement paste into the fiber matrix in order to create a physical bond between the concrete and the fiber. Cement absorption capacity of the reinforcing fibers is influenced by numerous characteristics, and combinations thereof, including material of construction, fiber diameter, pore size formed within the fiber strand, and the hydrophilic/hydrophobic nature of the carbon fibers and/or co-fibers. Although various combinations of those characteristics may affect the water absorption capability, any fiber may be conveniently characterized for cement absorption capacity by methods known to those skilled in the art. One such test measures a water-holding ratio. In one such test method, a fiber sample is immersed in water at a predetermined temperature and time, such as 25° C. for two hours. After the time has elapsed, the fiber is removed from the water and blotted dry with cloth or paper. The fiber is weighed (designated w₁) and then dried in a hot air current drier at elevated temperature, such as 50° C. to 80° C. until a constant weight is achieved (designated w₂). The water-holding ratio is calculated by: ((w₁−w₂)/w₂)*(100). In some embodiments the water-holding ratio of the reinforcing fiber assemblies is greater than about 1, such as 2, 5, 10, 20, 30 or more, and ratios thereof such as from about 1 to about 30, from about 5 to about 30, or from about 10 to about 30. The water absorption capability of the reinforcing fiber assemblies of the present disclosure is achieved using a carbon fiber tow having a water absorption capability of greater than 1, or one or more co-fibers having a water absorption capability of greater than 1, or a combination thereof.

The average reinforcing fiber assembly 13 length is suitably from 9 cm to about 50 cm, from 9 cm to about 25 cm, from 9 cm to about 20 cm, from 9 cm to about 15 cm, for instance, 9 cm, 10 cm, 11 cm, 12 cm, 13 cm, 14 cm, 15 cm, 16 cm, 17 cm, 18 cm, 19 cm or 20 cm, and ranges thereof. In some other embodiments, a varying length distribution of a range of from about 1 to about 50 cm, or from about 5 to about 50 cm, or from 9 cm to about 50 cm is used. The average diameter of the reinforcing fiber assembly 13 is suitably from about 1 mm to about 10 mm, from about 2 mm to about 8 mm or from about 3 mm to about 8 mm, such as about 2 mm, 3 mm, 4 mm, 5 mm, 6 mm, 7 mm or 8 mm. It is believed that the dimensions of the reinforcing fiber assemblies 13 of the present disclosure increases the available reinforcing fiber assembly surface area for bonding with concrete as compared to shorter reinforcing fibers known in the art thereby resulting in an enhanced bonding strength per fiber and a concomitant higher required energy input for reinforcing fiber assembly pullout from the concrete. In any of the various embodiments of the present disclosure, each fiber making up the reinforcing fiber assembly 13 is suitably from about 1 to about 100 microns in diameter, from about 1 to about 50 microns, form about 5 to about 50 microns, from about 5 to about 25 microns or from about 5 to about 15 microns.

In any of the various embodiments, it is believed, without being bound by any particular theory, that 9 cm to 50 cm long reinforcing fiber assemblies 13 of the present disclosure provide for improved reinforcing characteristics as compared to reinforcing fibers having a length of less than 9 cm. In particular, it is believed that the reinforcing fiber assemblies 13 of the present disclosure provide for improved concrete integrity upon exposure to blast forces or seismic events by: (i) effectively enabling any exposed carbon fiber to absorb cement paste into the structure, (ii) creating a stronger bond with the cementitious matrix through a combination of fibrous texture and irregular surface texture and (iii) creating a strong bond between the reinforcing fiber and concrete due to the increased fiber surface resulting from the fiber length.

### Concrete

Suitably, the concrete (as shown for example in FIG. 1) is made from cement, such as Portland cement, or a mix comprising cement, such as Portland cement, and slag and/or stone and/or sand and/or other aggregates. For example, in one embodiment, slag may be present in an amount up to about 25% of the weight of dry ingredients of the concrete mix. For example, Portland cement components may include calcium (Ca), silica (Si), aluminum (Al), and iron (Fe). The calcium may be provided in the form of limestone or calcium carbonate (CaCO₃), the silicon in the form of sand (SiO₂), shale and/or clay, which may contain silicon dioxide, aluminum oxides, and iron (III) oxides, and iron ore. Aggregate may also be added to form a concrete mix, or concrete. Suitable aggregate may include stone, slag, rock, ores, and other materials.

Concrete may be varied in composition so as to provide the desired characteristic properties required for a particular application. For example, a concrete slurry in accordance with the disclosure may contain 10 to 18% cement, 60 to 80% aggregate, 15 to 20% water, and 0.5 to 2% carbon fibers. Entrained air in the slurry may take up to about 8%. Additionally, concrete slurries having different percentages of components than those percentages of the example of this paragraph are included within the scope of this disclosure.

The fibrous material may be added to concrete as a dry mix or may be directly added by admixing with a concrete slurry. In some embodiments, the fibrous material is added to the concrete slurry prior to or after the slurry is pumped into a concrete mixing truck. In some other embodiments, the fibrous material may be admixed with the concrete as the concrete is poured or after it is poured.

In some embodiments of the present disclosure, the reinforcing fiber assemblies 13 are of greater length than the thickness of the formed concrete object containing those fibers 15, such as wherein the length of the reinforcing fiber assembly is greater than the thickness of the object, and wherein the thickness is the smallest dimension of the object. For instance, 9 cm reinforcing fiber assemblies could be used in a 5 cm thick concrete slab. If the concrete thickness is greater than the reinforcing fiber assembly 13 length, then a random three-dimensional spatial orientation of the reinforcing fiber assemblies within the concrete matrix may result. It is believed that such an orientation does not provide the maximum possible reinforcing effect because a proportion of the fibers may be oriented generally parallel to a propagating crack. If the reinforcing fiber assemblies are longer than the thickness of the concrete the fibers will oriented generally parallel to the longer dimension, i.e., the length and width of the formed concrete object such as a slab or column. Thus the reinforcing fiber assemblies 13 will be generally be oriented perpendicular to the any propagating crack in the concrete and thereby provide improved reinforcing properties.

Reinforced concrete compositions may comprise from about 0.1 to about 5%, from about 0.5 to about 5%, from about 1 to about 5%, from about 2 to about 5%, from about 0.1 to about 2%, from about 0.1 to about 1%, from about 0.1 to about 0.5%, from about 0.5 to about 2%, from about 0.5 to about 1%, or from about 1 to about 2% by weight reinforcing fiber assemblies.

### EXAMPLES

### Example 1

Various carbon fiber types and assembly structures were evaluated for capability to reinforce concrete.

Each concrete slab evaluated in Example 1 was prepared from a concrete base mix comprising cement (605 kg/m³), crushed limestone coarse aggregate (19 mm maximum) (783 kg/m³), fine sand aggregate (783 kg/m³) and water (230 kg/m³) was used. A superplasticizer (Glenium® 3030 available from BASF) was to improve workability and achieve the desired flowability (slump). Fresh and hardened property tests were done on the base (without contained reinforcing medium) and the following properties were determined: Slump—22.9 cm; Density 2291 kg/m³); Compressive Strength—7,420 psi (51.2 MPa); and Flexural Strength—791 psi (5454 kPa).

Each slab evaluated in this example measured 122 cm (height) by 122 cm (width) by 5 cm (thickness) and was cast in pairs and was prepared from the above-described concrete base mix. Each panel was moist-cured for seven days (at 23±3° C.) using wet burlap and plastic followed by 21 days under ambient air conditions (at 23±3° C.).

The plain concrete panels were fabricated without reinforcement.

The welded wire mesh (WWR) panels were reinforced with a 15 cm×15 cm-W1.4×W1.4 WWR mesh placed at mid-depth and supported by four 30.5 cm long by 2.5 cm high steel strip chairs.

The Fiber Type A panels were reinforced with a 3,000 winding plain carbon fiber fabric weave having 40 percent epoxy preimpregnated coating. 10.5 cm lengths of Fiber Type A were formulated at 1.5 percent by volume in concrete. Those panels are denoted as “Fiber Type A.”

The Fiber Type B1 panels were reinforced with a reinforcing fiber assembly 13 formed from a 48K carbon fiber tow twined around a stiffer polypropylene backbone prepared by applying a light coating of thermally activated epoxy to the polypropylene immediately prior to twining with the carbon fiber tow. After twining, a heat treatment was used to partially bond the carbon fibers to the polypropylene core. 10 cm lengths of Fiber Type B1 were formulated at 1 percent by volume in the concrete base. Those panels are denoted as “Fiber Type B1.”

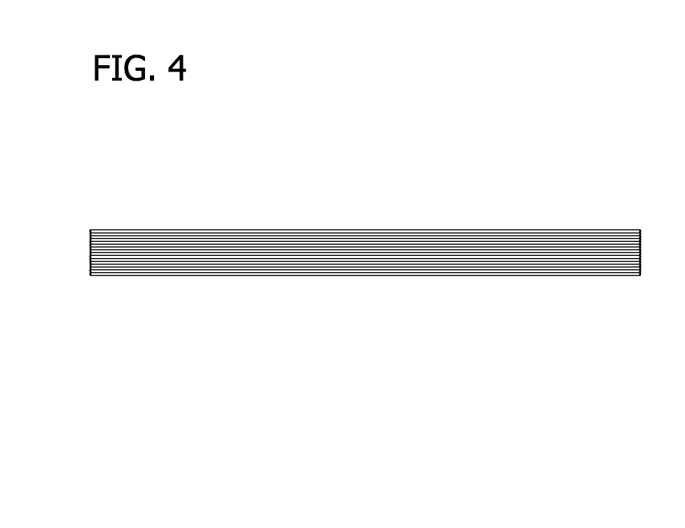

The Fiber Type B2 panels were reinforced with a reinforcing fiber assembly 13 prepared by placing the polypropylene used in Fiber Type B1 around a carbon fiber used in Fiber Type B1 (instead of twining as per the Type B1 fiber) thereby forming a jacket that provided the necessary fiber resiliency. A heat treatment process partially bonded the carbon fibers to the polypropylene jacket. Fiber Type B2 is similar to that shown in FIG. 4. 10 cm lengths of Fiber Type B2 were formulated at either 1 percent or 1.5 percent by volume in the concrete base. Those panels are denoted as “Fiber Type B2.”

Fiber Type B3 comprised a reinforcing fiber assembly 13 formed from a 48K carbon fiber tow twined around a stiffer polypropylene backbone or spine 17 that was then weaved with cotton string. The cotton weaving allowed for additional stability, improved fiber integrity during mixing and facilitated cement paste coating of the carbon fiber tow. Cotton has a water holding ratio of about 25 that is believed to facilitate cement paste penetration and coating of the Type B3 fiber. Fiber Type B3 is similar to that shown in FIGS. 2 and 3. 10 cm lengths of Fiber Type B3 were formulated at either 1 percent or 1.5 percent by volume in the concrete base. Those panels are denoted as “Fiber Type B3.”

In a series of drop tests, the control concrete panels, the WWR reinforced concrete panels, the Fiber Type A reinforced concrete panels and the Fiber Type B reinforced concrete panels were evaluated. Each concrete panel was tested in duplicate, designated as No. 1 and No. 2. The drop test apparatus is depicted in FIG. 4.5.

In the drop weight impact test, each panel was supported on a level, rigid steel frame with a 2-inch (51 mm) bearing support along each edge. The panels were unrestrained horizontally and upward vertically. A dynamic load cell was centered on the panel to measure the load subjected to each panel by the drop weight. The dynamic load cell was specially constructed using four individual dynamic load cells (supplied by PCB Piezotronics) and machined steel plates. By combining the four individual 20 kip (89 kN) capacity dynamic load cells, loads up to 80 kips (356 kN) of force could be measured. A ⅛-inch-thick (3.2 mm) neoprene square was placed under the load cell to reduce excessive vibrations of the load cell after impact. To measure deflection, a linear motion potentiometer with a 2-in.-stroke (51 mm) was secured under the panel. In order to measure rebound of the panel, the potentiometer was installed with an initial ½-in. deflection (12.7 mm).

The panels were impacted with a 50-pound (23 kg), 2¾ inch (70 mm) steel rod drop weight, guided by a 15-ft.-tall (4570 mm) section of PVC pipe at incremental heights until panel failure. To further reduce impact vibrations after the weight impacted the load cell, a ½-in.-thick (12.7 mm) section of high durometer neoprene was affixed to the striking end of the rod. For testing, each series began with a drop height of 3 in. (76 mm). The drop height increased by 3 in. (76 mm) for subsequent drops until a drop height of 24 in. (610 mm) was reached. From 24 in. (610 mm) until failure, the drop height increased by 6 in. (152 mm) each time. A Synergy Data Acquisition System recorded the load and deflection for each drop.

The results of the drop-weight impact test are summarized in Table 1a below. Cracking height refers to the weight drop height that resulting in slab cracking, but not failure. Failure height refers to the weight drop height that resulting in slab structural failure.

TABLE 1a
Drop-Weight Impact Test Results

| | Dosage Rate | Cracking Height | Failure Height |
|---|---|---|---|
| Panel | (%) | (cm.) | (cm.) |
| Plain Concrete No. 1 | None | 38 | 38 |
| Plain Concrete No. 2 | None | 46 | 46 |
| WWR No. 1 | None | 61 | 335 |
| WWR No. 2 | None | 46 | 305 |
| Fiber A No. 1 | 1.5 | 61 | 198 |
| Fiber A No. 2 | 1.5 | 61 | 198 |
| Fiber B1_No. 1 | 1.0 | 61 | 198 |
| Fiber B1_No. 2 | 1.0 | 76 | 168 |
| Fiber B2_No. 1 | 1.0 | 30 | 91 |
| Fiber B2_No. 2 | 1.0 | 30 | 137 |
| Fiber B2_No. 1 | 1.5 | 30 | 122 |
| Fiber B2_No. 2 | 1.5 | 23 | 122 |
| Fiber B3_No. 1 | 1.0 | 61 | 213 |
| Fiber B3_No. 2 | 1.0 | 91 | 229 |
| Fiber B3_No. 1 | 1.5 | 76 | 351 |
| Fiber B3_No. 2 | 1.5 | 122 | 366 |

All of the Fiber-reinforced panels clearly outperformed the plain concrete panels. Although the Fiber-reinforced panels exhibited a higher average cracking height, the WWR panels outperformed the Fiber B1 and B2 panels in failure height. The Fiber B3 panels at a 1.5 percent dosage rate outperformed the WWR panels in both cracking height and failure height. As expected, the plain concrete panels did not exhibit any visual cracking prior to failure.

Qualitative analysis of the panel impact damage provides an indication of how well the panels performed and their potential blast resistance. Both plain concrete panels exhibited sudden failure with similar cracking patterns, with four cracks spreading out from the center to the middle of each of the four panel sides. The sudden failure of the two plain concrete panels was expected and evidences why reinforcement, either mild steel and/or fibers, is necessary in the concrete matrix.

A visual comparison of the WWR panels and fiber-reinforced panels offers clues as to how the fiber reinforced concrete will respond to a blast event. The WWR panels failed at higher heights than the Fiber B1 and Fiber B2 panels. However, the WWR panels displayed significantly more damage that would be extremely harmful in a blast event. The WWR panels had a significant amount of spalling (fragmentation) and cracking compared to the LCFRC panels. The improved dynamic response of the LCFRC can be attributed to the energy absorbed by the 10 cm carbon fibers by pullout and the ability to maintain post-crack continuity. Both of these attributes should significantly improve the blast resistance of the LCFRC.

In summary, the addition of carbon fibers having a length of greater than 9 cm significantly increased the impact resistance of the panels as compared to the plain concrete panels. The WWR panels displayed significantly more damage, both in terms of spalling (fragmentation) and the extent of cracking than the fiber-reinforced panels. The addition of carbon fibers having a length of greater than 9 cm, which distribute throughout the specimen, provides superior spalling (fragmentation) resistance when exposed to impact loading.

### Example 2

In a series of blast tests, steel reinforced concrete panels further comprising Fiber Type A and steel reinforced concrete panels further comprising reinforcing fiber assembly Type B1 concrete panels were evaluated as compared to steel reinforced concrete panels not containing fiber reinforcement. Each concrete panel was tested in duplicate.

The concrete mix and curing protocol was the same as for Example 1. Each panel was reinforced with #4 bars spaced at 6 inches (30.5 cm) on center in each direction, on both top and bottom mats for of the panel. Due to the lack of distance to develop the bottom reinforcing steel for flexure, 180-degree hooks were required. For shear, #3 bars were placed at every other intersection with the top having a 135-degree bend and the bottom having a 90-degree bend.

A total of seven panels, each measuring 183 cm square and 16.5 cm thick were prepared. Three panels had no fiber reinforcement. Two panels were reinforced with 10 cm long by 1 cm wide Fiber A at 1.5 percent by volume. Two panels were reinforced with 10 cm long Fiber B1 described in Example 1 at 1 percent by volume.

After the blast frame was placed on the ground, a trench was excavated from the center of the panel to the top of the nearest berm. Within the trench, the researchers placed steel pipe segments and then threaded the data acquisition cabling through the pipe for protection during the blast. After installing the cabling, the trench was covered with soil and subsequently covered with sand bags for added protection. Each panel was simply supported on the rigid blast frame with 3 inches of bearing along each edge and unrestrained horizontal and upward vertical movement. Two free field pressure sensors were placed 24.3 feet from the panel center to ensure that the blast propagated as the researchers assumed and that complete detonation of the explosives was attained. The blast testing used ANFO (ammonium nitrate/fuel oil) for the explosive. Prefabricated cardboard tubes (Sonotubes) were used to position the explosive at the correct standoff distance.

Data recorded for each test included panel weights and permanent deflection. Each panel was weighed before and after the test. Permanent deformation was measured along the top of each panel using a large straight edge and ruler. Both the weight loss and permanent deformation were used to quantify the amount of damage during the blast.

Instrumentation for the blast test consisted of sensors to measure the incident and reflected pressures acting on the panels, and to insure that the blast propagated as the researchers assumed and that complete detonation of the explosives was attained. The instrumentation included pressures sensors installed in the panels to measure the reflected pressures, as well as free field pressure sensors installed at 24.3 feet from the panel to measure the incident pressures. The pressures were recorded with a 16-channel, Synergy data acquisition system (DAQ) at 500,000 samples per second. General purpose ICP® pressure sensors were used for the panels manufactured by PCB Piezotronics (PCB), each rated up to 10,000 psi. PCB general purpose ICP pressure sensors rated up to 500 psi were used for the free field measurements.

The measured free blast pressures are reported in Table 2a below and the physical measurements of the blast test panels are reported in Table 2b below. Deformation in Table 2b refers to elastic deformation wherein the material returns to the original dimensions after exposure to force.

TABLE 2a
Measured Free Field Blast Pressures

| | Free Field Sensor | Free Field Sensor |
|---|---|---|
| Panel | No. 1 (psi) | No. 2 (psi) |
| Control Panel No. 3 | 200 | 203 |
| Fiber Type A No. 1 | 282 | 170 |
| Fiber Type A No. 2 | 203 | 196 |
| Fiber Type B1 No. 1 | 198 | 184 |
| Fiber Type B1 No. 2 | 208 | — |

TABLE 2b
Physical Measurements of Blast Test Panels

| | Deformation | Weight (kg) | | | Weight |
|---|---|---|---|---|---|
| Panel | (cm) | Before | After | Loss | Loss |
| Control Panel No. 3 | — | 1417 | 1063 | 354 | 25% |
| Fiber Type A No. 1 | 12.7 | 1418 | 1370 | 48 | 3.4% |
| Fiber Type A No. 2 | 11.4 | 1429 | 1392 | 36 | 2.5% |
| Fiber Type B1 No. 1 | 10.2 | 1429 | 1397 | 32 | 2.2% |
| Fiber Type B1 No. 2 | 12.7 | 1429 | 1374 | 41 | 2.9% |

The addition of the carbon fibers significantly increased the spalling (fragmentation) resistance of the concrete. In terms of the amount of material lost during the blast, the fiber reinforced concrete outperformed the non-fiber concrete by a factor of about 10. The carbon fibers also significantly reduced the amount of cracking associated with the concrete panel. The decreased cracking correlates to a significant increase in blast resistance for structures constructed with the fiber-reinforced concrete. In addition to a decrease in the total amount of material loss, there was a significant decrease in the number of large sections of concrete forcibly ejected from the bottom of the fiber-reinforced panels. This reduction ranged from 75 to 89 percent, and this improvement over traditional concrete would significantly reduce the lethality of a blast for personnel located behind a wall constructed from carbon-fiber reinforced concrete. Additionally, fiber-reinforced material provides greater elastic deformation that welded wire mesh or rebar.

### Example 3

The reinforcement capabilities of reinforcing fiber B3 described in Example 1 was evaluated in test for deflection versus load for a concrete beam prepared from a concrete mix described in Example 1 and containing 30 pounds per cubic yard (13.6 kg/0.77 m³; 1.1%).

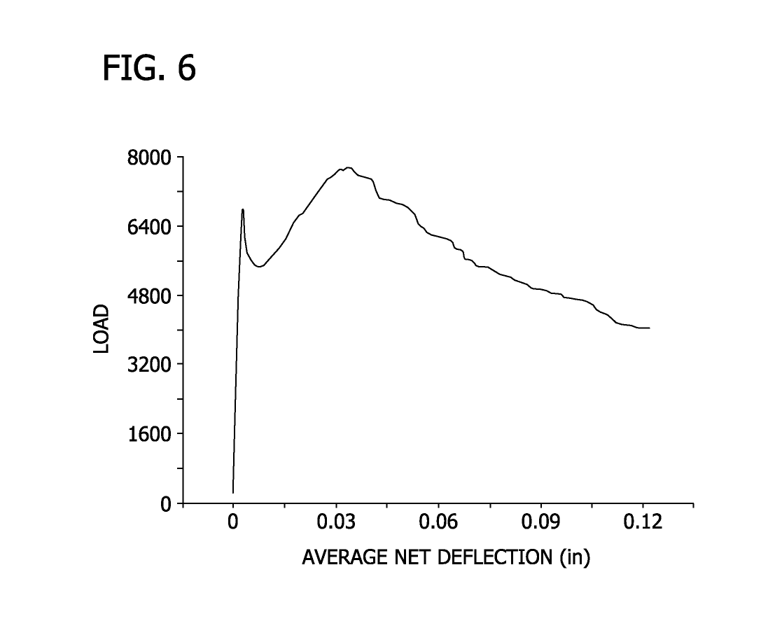

The test results are summarized in the below table 3 and in FIG. 6. In the table, “Width” refers to the width of the beam tested; “Depth” refers to the depth of the beam tested; “Support Span” refers to the bean span between the test supports; “Nose Span” refers to the span between beam loading points; “Peak Load” refers to the maximum load on the load-deflection curve (see FIG. 8); “L/600 (load)” refers to the load value corresponding to a net deflection of L/600; “L/400 (load)” refers to the load value corresponding to a net deflection of L/400; “L/300 (load)” refers to the load value corresponding to a net deflection of L/300; “L/150 (load)” refers to the load value corresponding to a net deflection of L/150; “L/600 (stress)” refers to the stress value obtained when the corresponding load is inserted into the formula for modulus of rupture (f=PL/bd²); “L/400 (stress)” refers to the stress value obtained when the corresponding load is inserted into the formula for modulus of rupture; “L/300 (stress)” refers to the stress value obtained when the corresponding load is inserted into the formula for modulus of rupture; “L/150 (stress)” refers to the stress value obtained when the corresponding load is inserted into the formula for modulus of rupture; “L/600 (energy)” and “L/150 (energy)” refer to the toughness or energy absorption and is represented by the area under the load-deflection curve up to each respective net deflection; “L/600 (Ratio)”, “L/400 (Ratio)”, “L/300 (Ratio)” and “L/150 (Ratio)” refer to the stress measured at that given deflection divided by the peak stress; “Fe3” refers to the equivalent flexural stress and refers to the average load over the area of the load-deflection curve up until a deflection of L/150 (3 mm or 0.12 inches) and is expressed as a stress; and “Re3” refers to equivalent flexural strength ratio and related to retention of load transfer capability and is calculated by dividing Fe3 by the peak stress and is expressed by a percentage.

As the data show, after initial cracking, the sample transferred more of the load to the carbon fiber (as indicated in the second peak of FIG. 6) and exceeded the initial load of the test. This result is surprising because it is believed that the reinforcing fibers was directly engaged within the concrete matrix and was able to absorb the applied load. The reinforcing fiber also enabled the concrete to be resilient (essentially ductile) and relax back to the unloaded position after removal of the load.

TABLE 3

| Width | 5.95 | in. |
|---|---|---|
| Depth | 5.90 | in |
| Support Span | 18.00 | in |
| Nose Span | 6.00 | in |
| Load at first crack | 6756 | lb-feet |
| Peak load | 7746 | lb-feet |
| Stress at first crack | 585 | psi |
| Peak stress | 675 | psi |
| Deflection at first crack | 0.0028 | in |
| Deflection at peak load | 0.0344 | in |
| L/600 (Load) | 7616 | lb-feet |
| L/400 (Load) | 6696 | lb-feet |
| L/300 (Load) | 6134 | lb-feet |
| L/150 (Load) | 4024 | lb-feet |
| L/600 (Stress) | 660 | psi |
| L/400 (Stress) | 610 | psi |
| L/300 (Stress) | 535 | psi |
| L/150 (Stress) | 350 | psi |
| L/600 (Energy) | 185 | in-lb |
| L/150 (Energy) | 694 | in-lb |
| L/600 (Ratio) | 97.8% | |
| L/400 (Ratio) | 90.4% | |
| L/300 (Ratio) | 79.3% | |
| L/150 (Ratio) | 51.9% | |
| Fe3 | 580 | psi |

| | |
|---|---|
| Re3 | 85.9% |

### Example 4

The reinforcement capabilities of fibers of the present disclosure was evaluated in test for concrete flexural strength.

Concrete beams having targeted dimensions of approximately 15.2 cm×15.2 cm×45.7 cm span were prepared from a concrete mix described in Example 1. A first set of beams consisted of three non-reinforced control beams, designated Control-1, Control-2 and Control-3. A second set of beams, designated as F1-1, F1-2 and F1-3 consisted of concrete reinforced with reinforcing fiber assembly B3 described in example 1 at a fiber addition rate of 1.0% fiber by volume. A third set of beams, designated as F2-1, F2-2 and F2-3 consisted of concrete reinforced with fiber B3 described in example 1 at a fiber addition rate of 1.5% fiber by volume.

The beams were tested using the experimental procedure of ASTM C78/C78M-10 Standard Test Method for Flexural Strength of Concrete Using Simple Beam with Third Point Loading (Aug. 1, 2010 approved version). The beams were evaluated at a load rate of 30 pounds per second to the breaking point, termed peak load. The results are presented Table 4 below where “b” refers to the beam width and “d” refers to the beam depth for each beam having a 45.7 cm span, “peak load” refers to the maximum beam load, and “No. Fibers” refers to the number of fibers in a cross section of the beam.

TABLE 4

| | | | Peak Load | |
|---|---|---|---|---|
| Specimen | b (cm) | d (cm) | (lb) | No. Fibers |
| Control-1 | 16.1 | 15.2 | 11,557 | 0 |
| Control-2 | 15.8 | 15.3 | 4,671 | 0 |
| Control-3 | 16.0 | 15.0 | 10,595 | 0 |
| F1-1 | 16.0 | 15.3 | 9,091 | 23 |
| F1-2 | 15.7 | 15.1 | 10,387 | 28 |
| F1-3 | 15.1 | 15.8 | 9,680 | 20 |
| F2-1 | 15.8 | 15.1 | 13,884 | 48 |
| F2-2 | 15.7 | 15.1 | 12,673 | 42 |
| F2-3 | 15.9 | 15.1 | 12,096 | 43 |

Control-2 failed prematurely and was considered to be an outlier. The test for specimen F1-1 was stopped prematurely and the results were not considered. Failure of the F1-2, F1-3, F2-1, F2-2 and F2-3 specimen beams occurred after initial concrete cracking.

The results indicated that the initial concrete cracking of the Control-1, Control-3, F1-2, F1-3, F2-1, F2-2 and F2-3 specimen beams occurred at generally similar loads. This is consistent with the properties of the concrete used in this evaluation. The initial cracking of the control beams coincided with beam failure because the unreinforced beams are unable to take any load after initial cracking. The carbon fiber reinforced beams were able to continue to take load after initial concrete cracking because additional loading is required to pull the fibers out of the concrete matrix. The beams having 1.0 vol % fiber addition displayed as second peak load (i.e., second load after cracking), but the load was less than the initial cracking load of the control beams. Those beams continued to take load after initial cracking until failure. The beams having 1.5 vol % fiber addition had a second peak load that was much higher than the initial cracking load of the control beams demonstrating that concrete reinforced with the fibers of the present disclosure is significantly stronger in flexure as compared to unreinforced concrete.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above apparatus and methods without departing from the scope of the disclosure, it is intended that all matter contained in the above description and shown in the accompanying figures shall be interpreted as illustrative and not in a limiting sense.

What is claimed:

1. A concrete reinforcing fiber assembly comprising:
a plurality of first fibers; and
at least one co-fiber attached to at least some of the first fibers,
wherein the reinforcing fiber assembly has a water absorption capability of greater than 1.

2. The concrete reinforcing fiber assembly of claim 1 wherein the first fibers and at least one co-fiber are fixed to one another.

3. The concrete reinforcing fiber assembly of claim 1 wherein the co-fiber is disposed around the first fibers and includes an over-lock stitch.

4. The concrete reinforcing fiber assembly of claim 1 wherein the co-fiber extends around the first fibers and is configured to inhibit pull-out of the concrete reinforcing fiber assembly from the concrete.

5. The concrete reinforcing fiber assembly of claim 4 wherein the co-fiber forms a non-uniform surface about first fibers to inhibit pull-out of the concrete reinforcing fiber assembly from the concrete.

6. The concrete reinforcing fiber assembly of claim 1 having a helical or screw-shaped configuration.

7. The concrete reinforcing fiber assembly of claim 1 wherein the co-fiber includes a resilient spine for inhibiting balling of the assembly.

8. The concrete reinforcing fiber assembly of claim 7 wherein the spine is selected from the group consisting of neoprene, rubber, nylon, PCV, polystyrene, polyethylene, polypropylene, and polyacrylonitrile, and co-polymers or combinations thereof.

9. The concrete reinforcing fiber assembly of claim 1 having a length of from 9 cm to about 50 cm and a diameter of between 3.175 mm and 6 mm, and wherein each fiber is between 6 and 9 microns in diameter.

10. The concrete reinforcing fiber assembly of claim 1 comprising from about 70% to about 99% by weight of carbon first fiber and from about 1% to about 30% by weight co-fiber.

11. The concrete reinforcing fiber assembly of claim 1 wherein the first fibers are made of carbon, and the co-fiber is selected from cotton, polymers, and/or combinations thereof.

12. The concrete reinforcing fiber assembly of claim 1 wherein the co-fiber:
is a polymeric fiber selected from the group consisting of cellulose, silicon carbide, pitch, polyamide, polyethylene terephthalate polyester, polybutylene terephthalate polyester, phenol-formaldehyde, polyvinyl alcohol, polyolefin, acrylic polyester, aromatic polyamide, polyethylene and polyurethane;
is a natural fiber selected from the group consisting of cotton, kapok, jute, flax, ramie, sisal, banana, agave, hemp, coir, bamboo, wool and silk; or
a combination thereof.

13. The concrete reinforcing fiber assembly of claim 1 wherein the first fiber is a carbon fiber having from about 30,000 to about 48,000 windings, and ranges thereof.

14. The concrete reinforcing fiber assembly of claim 1 wherein the first fiber is carbon fiber comprising carbon nanotubes.

15. The concrete reinforcing fiber assembly of claim 1 wherein the reinforcing fiber assembly has a water absorption capability of greater than 3.

16. The concrete reinforcing fiber assembly of claim 1 wherein:
(a) the first fiber is a carbon fiber tow having from about 30,000 to about 48,000 windings;
(b) the concrete reinforcing fiber assembly has a length of from 9 to 15 cm;
(c) the co-fibers are selected from the group consisting of cotton, Kevlar, acrylic polymer and combinations thereof; and
(d) the reinforcing fiber assembly has a water absorption capability of greater than 1.5.

17. A concrete composition comprising a reinforcing fiber assembly comprising:
a bundle of first fibers; and
at least one co-fiber disposed around the fibers,
wherein the reinforcing fiber assembly has a water absorption capability of greater than 1.

18. The concrete composition of claim 17 wherein the reinforcing fiber assembly has a length of from 9 cm to about 50 cm.

19. The concrete composition of claim 17 wherein the composition is an object having thickness, wherein the length of the reinforcing fiber assembly is greater than the thickness of the object, and wherein the thickness is the smallest dimension of the object.

20. The concrete composition of claim 17 wherein the reinforcing fiber assembly comprises a first fiber that is a carbon fiber tow having from 12,500 to 75,000 windings, and wherein the co-fiber is selected from cotton, polymers and/or combinations thereof.

21. The concrete composition of claim 17 wherein the reinforcing fiber assembly comprises from about 70% to about 99% by weight of a carbon fiber tow first fiber and from about 1% to about 30% by weight co-fiber and wherein the at least one co-fiber is weaved onto the carbon fiber tow.
